(19) United States
(12) Patent Application Publication
(10) Pub. No.: US 2026/0276982 A1
(43) Pub. Date: Sep. 17, 2026

(54) OPTICAL SYSTEM AND DISPLAY APPARATUS

(71) Applicant: CANON KABUSHIKI KAISHA, Tokyo (JP)

(72) Inventors: Yu MIYAJIMA, Tokyo (JP); Yoshihisa TASHIRO, Tochigi (JP)

(21) Appl. No.: 19/679,854

(22) Filed: May 18, 2026

Related U.S. Application Data
(63) Continuation of application No. PCT/JP2024/029003, filed on Aug. 14, 2024.

(30) Foreign Application Priority Data
Dec. 4, 2023 (JP) 2023-204659

(51) Int. Cl. G02B 27/00; G02B 13/00; G02B 27/01

(52) U.S. Cl. CPC G02B 27/0025; G02B 13/006; G02B 27/0172; G02B 2027/0116; G02B 2027/013

(57) ABSTRACT

An optical system may be configured to guide a light beam from a display surface to a pupil plane, and may include, in order from a pupil plane side to a display surface side, a first lens unit, a first transmissive reflective member having a first transmissive reflective surface, a second lens unit, a second transmissive reflective member having a second transmissive reflective surface, and a third lens unit. At least one optical surface of the first lens unit that forms an interface with air may be a first aspheric surface. At least one optical surface of the third lens unit that forms an interface with air may be a second aspheric surface.

### CROSS-REFERENCE TO RELATED APPLICATIONS

This application is a Continuation of International Patent Application No. PCT/JP2024/029003, filed on Aug. 14, 2024, which claims the benefit of Japanese Patent Application No. 2023-204659, filed on Dec. 4, 2023, both of which are hereby incorporated by reference herein in their entirety.

### BACKGROUND

### Field of the Technology

The present disclosure relates to an optical system and a display apparatus.

### Description of the Related Art

Recently, display apparatuses (observation apparatuses), such as head-mounted displays (HMDs), that provide a user with an immersive experience have been known. In such display apparatuses, an original image displayed using a display element such as a liquid crystal display (LCD) is enlarged and displayed via an observation optical system to provide a large-screen image to the user. Since the display apparatus is used while being worn on a head, the observation optical system used in the display apparatus is demanded to have a reduced size (thickness), a wide field of view, and high optical performance. Japanese Patent No. 6984261 discloses an optical system that reduces chromatic aberration by using a cemented lens.

### SUMMARY

An optical system according to one aspect of the present disclosure may be configured to guide a light beam from a display surface to a pupil plane, and may include, in order from a pupil plane side to a display surface side, a first lens unit, a first transmissive reflective member having a first transmissive reflective surface, a second lens unit, a second transmissive reflective member having a second transmissive reflective surface, and a third lens unit. At least one optical surface of the first lens unit that forms an interface with air may be a first aspheric surface. At least one optical surface of the third lens unit that forms an interface with air may be a second aspheric surface. A display apparatus having the above optical system includes another aspect of the present disclosure.

Features of the present disclosure will become apparent from the following description of embodiments with reference to the attached drawings. The following description of embodiments will be described by way of example.

### BRIEF DESCRIPTION OF THE DRAWINGS

FIGS. 1A and 1B are a sectional view and an aberration diagram of an optical system according to Example 1.

FIG. 2 is a schematic diagram illustrating an optical path of the optical system according to Example 1.

FIGS. 3A and 3B are explanatory diagrams of a first transmissive reflective surface and a second transmissive reflective surface.

FIG. 4 is a diagram illustrating an emission angle β of a display element relative to a half angle of field α in Example 1.

FIGS. 5A and 5B are diagrams illustrating the sectional shapes of a first aspheric surface and a second aspheric surface in Example 1.

FIGS. 6A and 6B are diagrams illustrating the local curvatures of the sectional shapes of the first aspheric surface and the second aspheric surface in Example 1.

FIGS. 7A and 7B are a sectional view and an aberration diagram of an optical system according to Example 2.

FIG. 8 is a schematic diagram illustrating an optical path of the optical system according to Example 2.

FIG. 9 is a diagram illustrating an emission angle β of a display element relative to a half angle of field α in Example 2.

FIGS. 10A and 10B are diagrams illustrating the sectional shapes of a first aspheric surface and a second aspheric surface in Example 2.

FIGS. 11A and 11B are diagrams illustrating the local curvatures of the sectional shapes of the first aspheric surface and the second aspheric surface in Example 2.

FIGS. 12A and 12B are a sectional view and an aberration diagram of an optical system according to Example 3.

FIG. 13 is a schematic diagram illustrating an optical path of the optical system according to Example 3.

FIG. 14 is a diagram illustrating an emission angle β of a display element relative to a half angle of field α in Example 3.

FIGS. 15A and 15B are diagrams illustrating the sectional shapes of a first aspheric surface and a second aspheric surface in Example 3.

FIGS. 16A and 16B are diagrams illustrating the local curvatures of the sectional shapes of the first aspheric surface and the second aspheric surface in Example 3.

### DESCRIPTION OF THE EMBODIMENTS

Referring now to the accompanying drawings, a detailed description will be given of examples according to the present disclosure.

An optical system according to each example is an optical system (a folded optical system) configured to guide a light beam from a display surface of a display element (panel unit) to an observation surface (pupil plane), and is an observation optical system for observing an image displayed on the display surface. A display apparatus includes the optical system according to each example and the display element. The optical system according to each example includes, in order from a pupil plane side toward a display surface side, a first lens unit (pupil-plane-side optical system), a first transmissive reflective member, a second lens unit (transmissive reflective optical system), a second transmissive reflective member, and a third lens unit (panel-side optical system).

The first transmissive reflective member has a first transmissive reflective surface that is planar or curved. The second transmissive reflective member has a second transmissive reflective surface that is curved. A lens closest to the display surface in the first lens unit and a lens closest to the pupil plane in the second lens unit are cemented via the first transmissive reflective member. A lens closest to the display surface in the second lens unit and a lens closest to the pupil plane in the third lens unit are cemented via the second transmissive reflective member.

The first lens unit is an optical system located between the pupil plane and the second lens unit. The second lens unit is an optical system located between two transmissive reflective surfaces (the first transmissive reflective surface and the second transmissive reflective surface) that function as both a transmissive surface and a reflective surface. The third lens unit is an optical system located between the second lens unit and the display element. Each of the first lens unit and the third lens unit may be omitted in some configurations. Each example will be described in detail below.

### Example 1

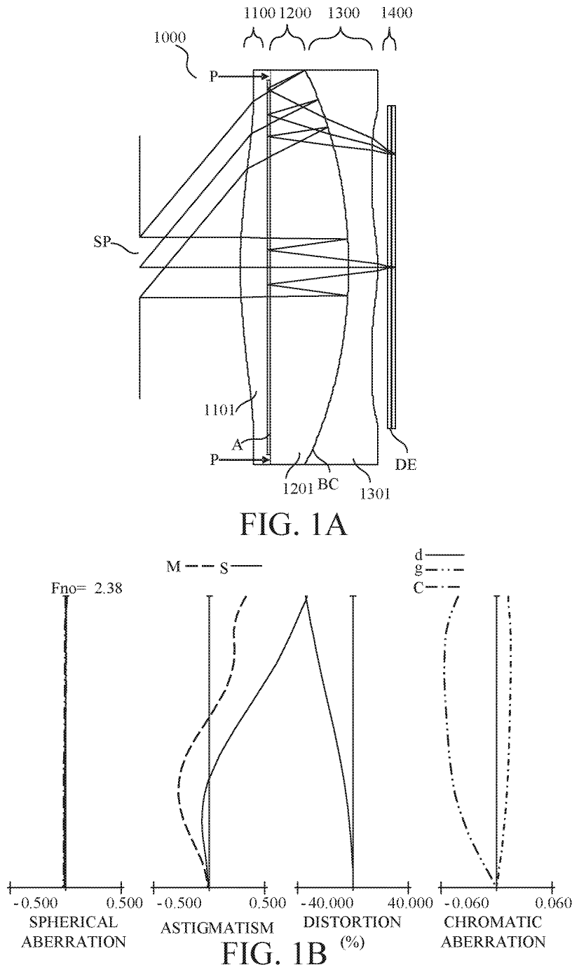

First, an optical system (observation optical system) 1000 according to Example 1 of the present disclosure will be described. FIG. 1A is a sectional view of the optical system 1000. The optical system 1000 includes a pupil-plane-side optical system (first lens unit) 1100, a first transmissive reflective member (A), a transmissive reflective optical system (second lens unit) 1200, a second transmissive reflective member (C), and a panel-side optical system (third lens unit) 1300.

The pupil-plane-side optical system 1100 includes an optical element (first lens) 1101. The transmissive reflective optical system 1200 includes an optical element (second lens) 1201 and an optical element (third lens) 1202. The panel-side optical system 1300 includes an optical element (fourth lens) 1301. In this example, the pupil-plane-side optical system 1100 includes one optical element, the transmissive reflective optical system 1200 includes two optical elements, and the panel-side optical system 1300 includes one optical element. These optical elements (optical elements 1101, 1201, 1202, and 1301) refract, reflect, or diffract light.

Each optical element has two optical surfaces, referred to as an R1 surface and an R2 surface in order from the pupil plane side. The R1 surface of the optical element 1101 is a curved surface, and the R2 surface is a planar surface. The R1 surface of the optical element 1201 is a planar surface, and the R2 surface is a curved surface. Both the R1 surface and the R2 surface of the optical element 1301 are curved surfaces. The optical elements 1101, 1202, and 1301 are formed of PMMA (acrylic resin). However, the configuration is not limited to this example, and acrylic resin may be applied to each optical element instead of forming each optical element of acrylic resin.

A light beam emitted from a panel unit (a display surface of a display element) 1400 passes through the panel-side optical system 1300 and the transmissive reflective optical system 1200, is reflected by the first transmissive reflective surface, is reflected by the second transmissive reflective surface, passes through the transmissive reflective optical system 1200 and the pupil-plane-side optical system 1100, and travels toward a pupil plane SP. Thereby, an optical image of the panel unit 1400 may be observed from the pupil plane SP at which an exit pupil of the optical system 1000 is located. Light traveling along this optical path will be referred to as desired light, and other light will be referred to as unnecessary light.

FIG. 1B illustrates an aberration diagram of the optical system 1000 in a case where an eye relief (a distance from the pupil plane SP to a pupil facing surface of the pupil-plane-side optical system 1100, which is a lens surface closest to the pupil plane in the pupil-plane-side optical system 1100) is 10 mm and a virtual image is displayed at a position 1600 mm from the pupil plane SP. FIG. 1B illustrates aberrations at wavelengths of the design reference wavelengths, namely the d-line (587.6 nm), the F-line (486.1 nm), and the C-line (656.3 nm). As illustrated in FIG. 1B, although curvature of field and astigmatic difference slightly occur, imaging performance usable in practice is obtained. Here, FIG. 1B illustrates aberrations in a reverse optical path (reverse trace) from the pupil plane SP toward the panel unit 1400 with the panel unit 1400 regarded as an image plane, rather than in a forward optical path (forward trace) from the panel unit 1400 toward the pupil plane SP. This does not cause a problem because the aberrations correspond to those in the forward optical path when optical performance of the optical system 1000 is illustrated. In addition, regarding a polarizer, a quarter waveplate, and a polarization-selective transmissive reflective element described later, approximate properties of each element are uniformly described as an example as follows, although actual properties may differ. For example, the polarizer has a thickness of 0.1 mm, a refractive index of 1.52, and an Abbe number of 50. A quarter waveplate and a laminated element of the quarter waveplate and the polarization-selective transmissive reflective element have a thickness of 0.3 mm, a refractive index of 1.52, and an Abbe number of 50.

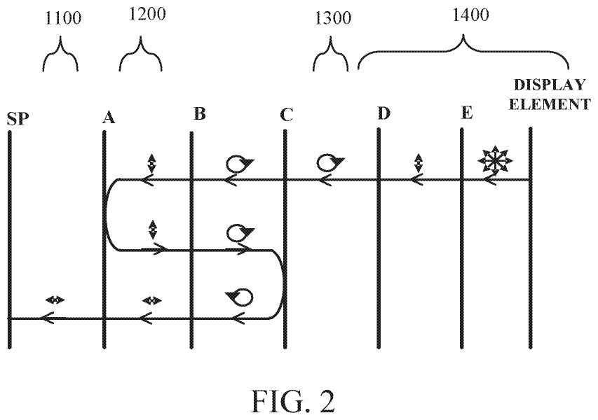

Next, with reference to FIG. 2, an optical path of the optical system 1000 will be described. FIG. 2 is a schematic diagram illustrating the optical path of the optical system 1000, and illustrates directions of the optical path passing through respective surfaces and polarization states above the optical path. Here, only the optical path of desired light will be described, and optical paths of unnecessary light caused by respective components of the optical system 1000 will be omitted.

The optical system 1000 includes, in order from the pupil plane SP, the pupil-plane-side optical system 1100, a polarization-selective transmissive reflective element A, the transmissive reflective optical system 1200, a first quarter waveplate B, a transmissive reflective surface (half-mirror) C, the panel-side optical system 1300, and the panel unit 1400. The polarization-selective transmissive reflective element A corresponds to the first transmissive reflective member having the first transmissive reflective surface, and the transmissive reflective surface C corresponds to the second transmissive reflective member having the second transmissive reflective surface. The panel unit 1400 includes a display element (light modulation element) such as a liquid crystal display element or an organic EL element, a polarizer E, and a second quarter waveplate D. A shape of the display element is a square having a diagonal of 1.3 inches (a side length of 23.3 mm). From the display element toward the pupil plane side, the polarizer E and the second quarter waveplate D are arranged in this order.

An unpolarized light beam emitted from the display element becomes linearly polarized light at the polarizer E and is converted into circularly polarized light by the second quarter waveplate D. The light then passes through the panel-side optical system 1300 and travels toward the transmissive reflective optical system 1200. The polarizer E may be integrated with the image display element. For example, the liquid crystal display element includes a polarizer in its configuration. Further, in an organic EL element, a polarizer may be used for the purpose of suppressing reflection, and in such a case light emitted from the image display element becomes linearly polarized light. In these cases, it is unnecessary to separately provide the polarizer E.

The polarization-selective transmissive reflective element A and the transmissive reflective surface (half-mirror) C are two transmissive reflective surfaces (the first transmissive reflective surface and the second transmissive reflective surface) that function as both a transmissive surface and a reflective surface. The transmissive reflective surface (half-mirror) C is formed of a dielectric multilayer film or a metal film and functions as the transmissive reflective surface (the second transmissive reflective surface). The thickness of the transmissive reflective surface (half-mirror) C is typically 1000 nm or less and at most 5000 nm. In numerical examples, the thickness of the transmissive reflective surface is not considered (that is, the thickness is omitted).

The first quarter waveplate B is disposed such that a slow axis of the first quarter waveplate B is tilted by 45° relative to a polarization transmission axis of the polarizer E, and slow axes of the first quarter waveplate B and the second quarter waveplate D are tilted by 90° relative to each other. The transmissive reflective surface (half-mirror) C is deposited on the R1 surface of the optical element 1301 and is further adhered to the R2 surface of the optical element 1202. The first quarter waveplate B is adhered to the R1 surface of the optical element 1201 and is further adhered to the polarization-selective transmissive reflective element A adhered to the R2 surface of the optical element 1101.

The polarization-selective transmissive reflective element A is configured to reflect linearly polarized light having the same polarization direction as that when passing through the polarizer E and to transmit linearly polarized light having a polarization direction orthogonal to it. That is, the polarization-selective transmissive reflective element A is a reflective polarizer configured to separate incident light into reflected light and transmitting light according to a polarization state. For example, the polarization-selective transmissive reflective element A may be a wire grid polarizer or a laminated birefringent film polarizer. A specific example of a wire grid polarizer is “WGF” manufactured by Asahi Kasei Corporation, in which a wire grid formation surface functions as a transmissive reflective surface. The thickness of the polarization-selective transmissive reflective element A is typically 0.5 mm or less and at most 1 mm.

A transmissive reflective member includes a transmissive reflective surface and a member continuous with the transmissive reflective surface, and does not substantially have refractive power. The transmissive reflective member mainly performs optical functions other than refraction (such as absorption according to a polarization state, change in a polarization state, and antireflection) and mechanical functions (such as adhesion and protection). In this example, the polarization-selective transmissive reflective element A is the first transmissive reflective member, and the transmissive reflective surface (half-mirror) C is the second transmissive reflective member. Each transmissive reflective member may include a plurality of members having respective functions.

Of light incident on the transmissive reflective surface (half-mirror) C, desired light passes through the transmissive reflective surface (half-mirror) C and is converted into linearly polarized light having the same polarization direction as that when passing through the polarizer E by the first quarter waveplate B. The light then enters the polarization-selective transmissive reflective element A. This linearly polarized light is reflected by the polarization-selective transmissive reflective element A due to its polarization selectivity. Light reflected by the polarization-selective transmissive reflective element A is converted by the first quarter waveplate B into the same circularly polarized light as that when it was first converted into circularly polarized light by the second quarter waveplate D, and the light then enters the transmissive reflective surface (half-mirror) C and is reflected there. The light reflected by the transmissive reflective surface (half-mirror) C becomes circularly polarized light having a rotation direction opposite to that before reflection, enters the first quarter waveplate B again, and is converted into linearly polarized light having a polarization direction orthogonal to the polarization direction when the light first passed through the polarizer E. The light then enters the polarization-selective transmissive reflective element A and passes through the polarization-selective transmissive reflective element A due to the polarization selectivity thereof, and is guided to the pupil plane SP.

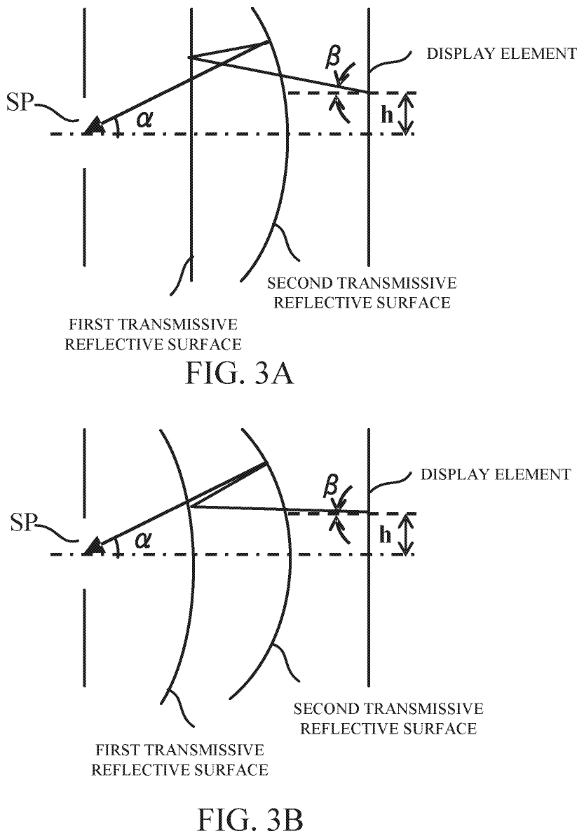

FIGS. 3A and 3B are schematic diagrams illustrating an optical path of a light beam emitted from an image height (height h) on the display element, an emission angle β of the display element (an angle relative to a normal of the display surface of the display element), and a half angle of field α on the pupil plane SP according to the plano-convex shape of the first transmissive reflective surface. Here, in order to explain the influence of reflection, the influence of refraction is not illustrated. Further, for simple description, the description is made using approximately spherical shapes rather than complicated aspherical shapes. Details of FIGS. 3A and 3B will be described later.

Since the display element usually performs Lambertian emission, an amount of captured light increases as the emission angle β reduces, and the amount of captured light decreases as the emission angle β increases. Thus, when a maximum value of the emission angle β increases within a design angle of field, unevenness of light amount distribution occurs in a field of view. As described above, as a half angle of field α increases (that is, an angle of field increases), a stronger sense of immersion can be obtained, but at the same time the maximum value of the emission angle β tends to increase, which may cause a problem.

Although depending on characteristics of the display element, when an emission angle β (a maximum absolute value of the emission angle β) exceeds 35°, unevenness of light amount distribution may easily become problematic. Therefore, the emission angle β of a principal ray of a light beam passing through the pupil plane SP from the display element (a maximum absolute value of the emission angle β) may be 35° or less. The emission angle β may be 30° or less. In order to reduce the maximum absolute value of the emission angle β, a configuration in which an aspheric surface is provided on an optical surface that forms an interface with air in the panel-side optical system may be adopted. This is because, in the panel-side optical system, light beams corresponding to respective angle of fields are separated compared with those in the pupil-plane-side optical system or the transmissive reflective optical system.

On the other hand, when a configuration of the panel-side optical system is designed with priority given to the emission angle β, curvature of field and astigmatic difference may become inappropriate. In order to improve this, a configuration in which an aspheric surface is provided on an optical surface that forms an interface with air in the pupil-plane-side optical system may be adopted. In the transmissive reflective optical system, even light beams having the same angle of field pass through different positions of optical surfaces in three folded optical paths, and therefore optimization of light beams for each angle of field is difficult. In addition, since the pupil-plane-side optical system is separated from the panel-side optical system, curvature of field and astigmatic difference may be adjusted relatively easily by the aspheric surfaces provided in these optical systems. Even when an aspheric surface is provided on an cemented surface instead of an interface with air, the effect of refraction reduces and a desired effect may not be obtained.

In this example, a maximum half angle of field of a design angle of field in the designed name is assumed to be 50°. More specifically, a maximum angle of a principal ray of a light beam passing through the pupil plane SP is 50°. In general, as long as a maximum half angle of field (a maximum angle of a principal ray passing through the pupil plane SP) is 30° or more, the optical system can be regarded as a wide-field optical system. The maximum half angle of field may be 40° or more. As the angle of field increases, the effect of this example is improved.

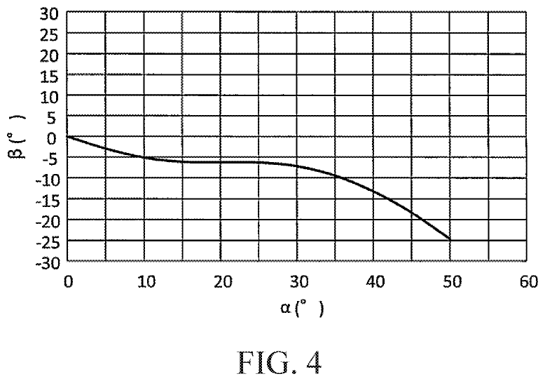

FIG. 4 illustrates an emission angle β (an angle relative to a normal of the display element) of a principal ray relative to a half angle of field α in the optical system 1000 according to this example. In FIG. 4, a horizontal axis represents a angle of field (°), and a vertical axis represents the emission angle β (°). As illustrated in FIG. 4, the emission angle β is defined as negative (−) when a light beam is emitted in a direction away from the optical axis, and positive (+) when the light beam is emitted in a direction approaching the optical axis. As illustrated in FIG. 4, the emission angle β at the maximum half angle of field (α=50°) is −24.6°, and a maximum absolute value of the emission angle β is smaller than 30° (unevenness of light amount distribution is evaluated based on an absolute value rather than a sign). That is, the configuration according to this example can suppress unevenness of light amount distribution.

In addition, in a case where the emission angle β at the maximum half angle of field is negative as in this example (that is, in a case where a light beam is emitted in a direction away from the optical axis at an angle of field at an end portion of the display element), the size of the display element can be reduced, which is beneficial in terms of weight and cost. For example, assuming that the maximum half angle of field is 30° or more, the shape of the display element may be such that a diagonal length of a circumscribed square of the display element is 1.6 inches or less (a side length of the circumscribed square is 28.7 mm or less).

Next, details of FIGS. 3A and 3B will be described. FIG. 3A illustrates the case where the first transmissive reflective surface has a planar shape and the second transmissive reflective surface has a shape concave toward the pupil plane side. This configuration is suitable for increasing the half angle of field α, but is not suitable for reducing the emission angle β. FIG. 3B illustrates the case where both the first transmissive reflective surface and the second transmissive reflective surface have shapes concave toward the pupil plane side. This configuration is suitable for reducing the emission angle β and increasing the half angle of field α. That is, when only the influence of reflection is considered, the configuration in which both the first transmissive reflective surface and the second transmissive reflective surface have shapes concave toward the pupil plane side, as illustrated in FIG. 3B, may be beneficial in terms of the emission angle β and the half angle of field α. In other words, a configuration in which the first transmissive reflective surface has a planar shape as in this example is particularly effective for reducing the emission angle β due to the influence of refraction. Further, the configuration in which the first transmissive reflective surface is planar can facilitate manufacturing compared with the configuration in which the first transmissive reflective surface is curved.

In this example, the optical element 1101 (a lens closest to the display surface in the first lens unit), which is a refractive (dioptric) optical element, and the optical element 1201 (a lens closest to the pupil plane in the second lens unit), which is also a refractive optical element, are cemented via the first transmissive reflective member including the first transmissive reflective surface. The optical element 1201 (a lens closest to the display surface in the second lens unit) and the optical element 1301 (a lens closest to the pupil plane in the third lens unit) are cemented via the second transmissive reflective member including the second transmissive reflective surface.

Such a configuration in which a transmissive reflective member including a transmissive reflective surface is sandwiched by refractive optical elements can reduce refractive power at the transmissive reflective surface compared with a configuration in which the transmissive reflective surface contacts air. As a result, when the shape of the transmissive reflective surface is determined, the influence of reflective power can mainly be considered. Thereby, a degree of freedom in optical design can increase, and imaging performance can be improved while the emission angle β is reduced.

In particular, in an attempt to secure the imaging performance at a wide angle of field, the second transmissive reflective surface may have a shape concave toward the pupil plane side and may have large reflective power as in this example. In such a configuration, the above-described effect may increase. That is, the above configuration provides a greater effect. On the other hand, in a case where the first transmissive reflective surface has a planar shape as in this example, the effect of adopting the above configuration is smaller from viewpoints of reducing the emission angle β and improving imaging performance. However, since an unnecessary space is not provided, there are advantages in that an overall optical length can be reduced, manufacturing and holding can be simplified, and the durability described later can be improved. The effects of this example can be obtained even when the above-described cementing configuration is not adopted.

In addition, in this example, the pupil-plane-side optical system, the transmissive reflective optical system, and the panel-side optical system each include one optical element, i.e., a total of three optical elements. That is, the first lens unit includes a first lens (optical element 1101), the second lens unit includes a second lens (optical element 1201), and the third lens unit includes a third lens (optical element 1301). The first lens and the second lens are cemented via the first transmissive reflective member, and the second lens and the third lens are cemented via the second transmissive reflective member. Due to such a configuration, the number of optical elements required for obtaining the above effects can be minimized, which is beneficial in terms of cost and manufacturing. Here, cementing includes not only adhesion using an adhesive agent but also deposition, pressure bonding, and the like. Further, cementing refers to cementing at least within a part of an effective region through which a light beam passes, and does not necessarily include cementing in an entire effective region or cementing outside the effective region. This example can secure a degree of freedom in optical design and provide high-definition images.

As described above, an observation optical system used in a display apparatus may have a reduced size (thickness). For example, in order to reduce the size (thickness) of the observation optical system, a distance from an optical surface facing the pupil plane SP to the display surface of the display element may be 20 mm or less. The distance may be 17 mm or less. In this example, the distance from the optical surface facing the pupil plane SP to the display surface is 15.5 mm, and therefore the size (thin) of the optical system can be sufficiently reduced.

In order to reduce the size (thickness), a focal length may be reduced to approximately the same level as the distance from the optical surface facing the pupil plane SP to the display surface. In other words, in order to reduce the size (thickness) of the observation optical system, the focal length of the observation optical system may be 20 mm or less. The focal length may be 17 mm or less. In this example, the focal length is 14.3 mm, and therefore the size (thickness) of the optical system can be sufficiently reduced. When the focal length is reduced at a wide angle of field, curvature of field and astigmatic difference tend to deteriorate. Therefore, as the size (thickness) of the optical system reduces, the effect of this example increases.

As a method for reducing the focal length, a configuration in which the powers on the optical axis (refractive power near the optical axis) of both the pupil-plane-side optical system (first lens unit) and the panel-side optical system (third lens unit) are positive may be adopted. Since the transmissive reflective optical system has positive on-axis power in terms of imaging performance, the on-axis powers of all three optical systems becomes positive. Thereby, the focal length may be reduced more easily compared with a configuration in which the on-axis power of either one or both of the pupil-plane-side optical system and the panel-side optical system is negative. In this example, the focal length of the pupil-plane-side optical system is 103.7 mm and the focal length of the panel-side optical system is 31.3 mm, both of which are positive.

Next, an aspherical shape of an optical surface that forms interfaces with air in the pupil-plane-side optical system (first lens unit) and the panel-side optical system (third lens unit) will be described. In order to reduce the emission angle β while improving curvature of field and astigmatic difference, at least one optical surface in an effective region of a light beam may have a high-order aspherical shape. More specifically, a sectional shape including the optical axis may have a shape that cannot be expressed by a conic curve (that is, an ellipse, a parabola, or a hyperbola).

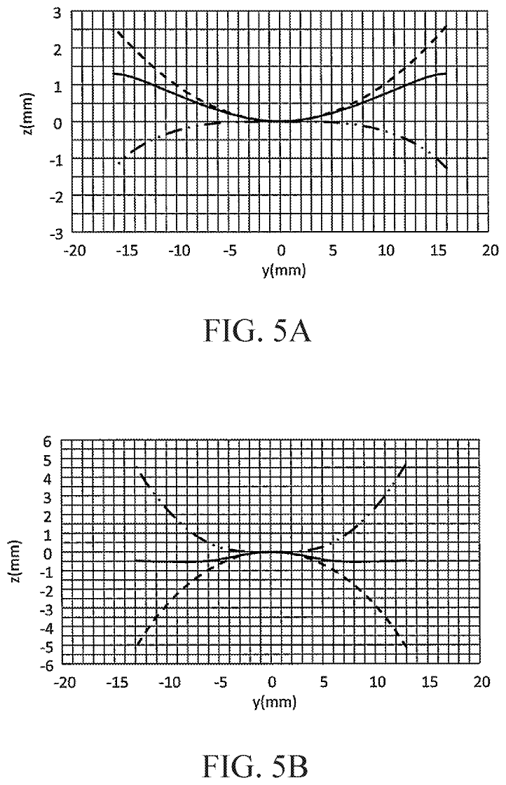

FIG. 5A illustrates, by a solid line, a sectional shape including the optical axis of the R1 surface of the optical element 1101. FIG. 5B illustrates, by a solid line, a sectional shape including the optical axis of the R2 surface of the optical element 1301. In FIGS. 5A and 5B, a position in an optical-axis direction is represented by z (positive from the pupil plane side toward the panel side), a radial distance is represented by y, and a surface vertex is represented by z=0 mm. In FIGS. 5A and 5B, a horizontal axis represents the distance y (mm), and a vertical axis represents the position z in the optical-axis direction (mm). A scale of the graph differs for each surface. As illustrated in FIGS. 5A and 5B, both sectional shapes have shapes that cannot be expressed by conic curves.

Thus, in this example, at least one optical surface of the first lens unit that forms an interface with air is a first aspheric surface, and at least one optical surface of the third lens unit that forms an interface with air is a second aspheric surface. A section including the optical axis of at least one of the first aspheric surface or the second aspheric surface may have a shape that cannot be expressed by a conic curve.

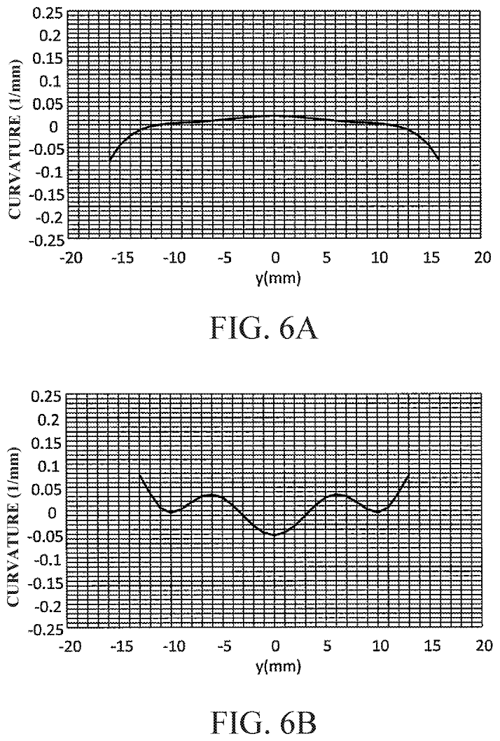

In order to consider optical action of such shapes, a local curvature corresponding to power in an optical-axis direction is evaluated. FIG. 6A illustrates a local curvature of a sectional shape including the optical axis of the R1 surface (the first aspheric surface) of the optical element 1101. FIG. 6B illustrates a local curvature of a sectional shape including the optical axis of the R2 surface (the second aspheric surface) of the optical element 1301. Here, the radial distance is represented by y. In FIGS. 6A and 6B, a horizontal axis represents the distance y (mm), and a vertical axis represents curvature (1/mm).

As illustrated in FIGS. 6A and 6B, both the first aspheric surface and the second aspheric surface have shapes in which curvature crosses zero (that is, reverses) toward an off-axis direction relative to an on-axis curvature, that is, shapes having inflection points. Adopting such shapes having local power distribution can reduce the emission angle β while improving curvature of field and astigmatic difference. In this example, both the first aspheric surface and the second aspheric surface have inflection points in sections including the optical axis. However, the configuration is not limited to this example, and a section including the optical axis of at least one of the first aspheric surface or the second aspheric surface may have an inflection point.

Further, as illustrated in FIG. 6B, the local curvature has five extrema within an effective diameter. By adopting such a shape in which local power changes finely so that the local curvature has three or more extrema, the emission angle β, the curvature of field, and the astigmatic difference may be improved over an entire angle of field. In particular, at a very wide angle of field as in this example, at least one optical surface may have such an aspheric surface. The local curvature correlates with a second derivative value of a surface shape. Therefore, the fact that the local curvature has three or more extrema is equivalent to the fact that the second derivative value of the surface shape has three or more extrema. That is, in this example, a section including the optical axis of at least one of the first aspheric surface or the second aspheric surface may have a shape whose second derivative has three or more extrema.

In FIG. 5A, a paraxial curvature surface of the sectional shape including the optical axis of the R1 surface of the optical element 1101 is illustrated by a dotted line, and a difference from the sectional shape is illustrated by an alternate long and two short dashes line. Similarly, in FIG. 5B, a paraxial curvature surface of the sectional shape including the optical axis of the R2 surface of the optical element 1301 is illustrated by a dotted line, and a difference from the sectional shape is illustrated by a double-dashed line. The paraxial curvature surface refers to aspheric surface defined by curvature near the optical axis.

An absolute value of a ratio of this difference relative to the paraxial curvature surface represents a degree of asphericalness (referred to as asphericity). Although the effect is not strictly proportional to the asphericity, the effect of the present disclosure may increase when the asphericity becomes relatively large. Generally, the asphericity increases toward a maximum effective diameter end, and as long as the asphericity is 30% or more at the maximum effective diameter end, the effect of this example tends to be achieved. When the asphericity is 50% or more, the effect of this example can be sufficiently obtained.

In this example, in a section including the optical axis of at least one of the R1 surface of the optical element 1101 or the R2 surface of the optical element 1301, a sag amount of a paraxial curvature surface at a maximum effective diameter end is defined as SagR, and a sag amount of an aspheric surface (a sectional shape including the optical axis) is defined as SagA. In this case, the following inequality (1) may be satisfied:

$$0.3 \leq \vert ( SagA - SagR ) / SagR \vert \qquad ( 1 )$$

In this example, at the maximum effective diameter end (Φ32) of the R1 surface of the optical element 1101, the sag amount SagA is 1.30 mm and the sag amount SagR is 2.57 mm. The asphericity is calculated as follows:

$$\vert ( SagA - SagR ) / SagR \vert = 0.495 ( 49.5 \% )$$

Similarly, at the maximum effective diameter end (Φ26) of the R2 surface of the optical element 1301, the sag amount SagA is −0.46 mm and the sag amount SagR is −5.14 mm. The asphericity is calculated as follows:

$$\vert ( SagA - SagR ) / SagR \vert = 0.91 ( 91. \% )$$

Thus, when the asphericity is 30% or more in both of the two aspheric surfaces, that is, the R1 surface of the optical element 1101 and the R2 surface of the optical element 1301, the effect of this example can be sufficiently obtained. In particular, the asphericity of the R2 surface of the optical element 1301 is 50% or more, and therefore the effect may become larger.

In this example, an Abbe number of the optical element 1201 based on the d-line is defined as ν12, and an Abbe number of the optical element 1301 based on the d-line, which is bonded to the optical element 1201 across the second transmissive reflective surface, is defined as ν13. In this case, ν12=56.0 and ν13=22.38, and therefore |ν12−ν13|=33.62. By using glass materials having an Abbe number difference of 20 or more across a cemented surface, chromatic aberration may be reduced while reducing an overall optical length. In this case, the effect of this example can be obtained for any combination of optical elements across any cemented surface included in the optical system.

Here, instead of reducing chromatic aberration near the optical axis as in this example, such a configuration may also be adopted in order to obtain an effect of reducing off-axis chromatic aberration. When an Abbe number of one optical element (one of two adjacent lenses) based on the d-line is defined as ν1 and an Abbe number of the other optical element based on the d-line is defined as ν2 across a cemented surface included in the optical system, at least one combination that satisfies the following inequality (2) may be included.

$$20 \leq \vert v 1 - v 2 \vert \qquad ( 2 )$$

Inequality (2) may be replaced with the following inequality (2a):

$$25 \leq \vert v 1 - v 2 \vert \qquad ( 2 a )$$

Inequality (2) may be replaced with the following inequality (2b):

$$30 \leq \vert v 1 - v 2 \vert \qquad ( 2 b )$$

In this example, a side surface of the first transmissive reflective member including the polarization-selective transmissive reflective element A in a direction perpendicular to the optical axis is sealed by cementing outer shapes of the optical element 1101 and the optical element 1201 (P in FIG. 1A), and therefore does not contact air. By adopting such a configuration in which the transmissive reflective surface does not directly contact air, deterioration in performance or durability due to moisture absorption can be prevented. However, this example is not limited to this example, and at least one of the first transmissive reflective member or the second transmissive reflective member may not contact air.

In this example, the diameter of the first transmissive reflective member is smaller than the diameters of the optical element 1101 and the optical element 1201 to form the above configuration, but this is not essential. For example, the diameter of the transmissive reflective member and the diameters of refractive optical elements cemented to it may be equivalent, and a protective film may be provided on a side surface of the transmissive reflective member in a direction perpendicular to the optical axis, or the side surface may be covered with another member.

In this example, PMMA (acrylic resin), which has hardness and chemical resistance higher than those of ordinary resins, is used as a material of the optical element 1101 having an optical surface facing the pupil plane SP. Since the optical surface facing the pupil plane SP may be touched by an observer, antifouling standards are generally strict. Thereby, even when stricter antifouling standards are required, a hard coating or antifouling glass may not need to be provided, and a cost reduction effect may be obtained.

### Example 2

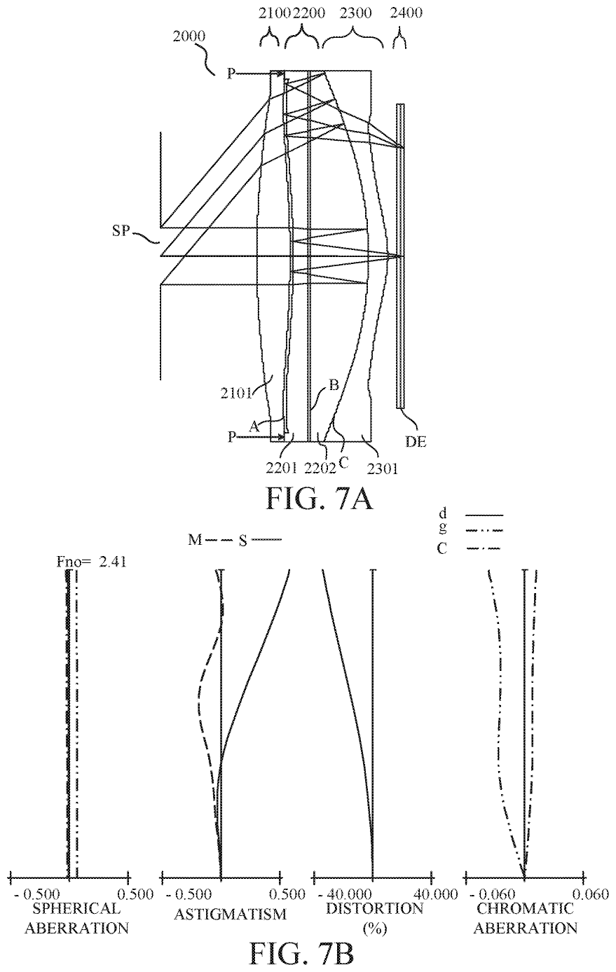

Next, an optical system (observation optical system) 2000 according to Example 2 of the present disclosure will be described. This example will omit a description common to Example 1. FIG. 7A is a sectional view of the optical system 2000. The optical system 2000 includes a pupil-plane-side optical system (first lens unit) 2100, a first transmissive reflective member (A), a transmissive reflective optical system (second lens unit) 2200, a second transmissive reflective member (C), and a panel-side optical system (third lens unit) 2300.

The pupil-plane-side optical system 2100 includes an optical element (first lens) 2101, the transmissive reflective optical system 2200 includes an optical element (second lens) 2201 and an optical element (third lens) 2202, and the panel-side optical system 2300 includes an optical element (fourth lens) 2301. Thus, in this example, the pupil-plane-side optical system 2100 includes one optical element, the transmissive reflective optical system 2200 includes two optical elements, and the panel-side optical system 2300 includes one optical element. These optical elements (optical elements 2101, 2201, 2202, and 2301) refract, reflect, or diffract light. The R1 surface and the R2 surface of the optical element 2101 are curved surfaces. The R1 surface of the optical element 2201 is a curved surface, and the R2 surface thereof is a planar surface. The R1 surface of the optical element 2202 is a planar surface, and the R2 surface thereof is a curved surface. The R1 surface and the R2 surface of the optical element 2301 are both curved surfaces. The optical element 2101 is formed of PMMA (acrylic resin).

A light ray from a panel unit (a display surface of a display element) 2400 passes through the panel-side optical system 2300 and the transmissive reflective optical system 2200, is reflected once by each of the first transmissive reflective surface and the second transmissive reflective surface, passes through the transmissive reflective optical system 2200 and the pupil-plane-side optical system 2100, and travels toward the pupil plane SP. Thereby, an optical image of the panel unit 2400 can be observed from the pupil plane SP at which an exit pupil of the optical system 2000 is located. Light traveling along this optical path is referred to as desired light, and other light is referred to as unnecessary light.

FIG. 7B illustrates aberration diagrams of the optical system 2000 in a case where an eye relief (a distance from the pupil plane SP to a pupil-facing surface of the pupil-plane-side optical system 2100, that is, a lens surface closest to the pupil plane in the pupil-plane-side optical system 2100) is 10 mm and a virtual image is displayed at a position 1600 mm from the pupil plane SP. As illustrated in FIG. 7B, favorable imaging performance is obtained. In particular, curvature of field and chromatic aberration are improved as compared with Example 1, and a reason therefor will be described later.

The configuration of the panel unit 2400 is equivalent to that of the panel unit 1400 in Example 1. The transmissive reflective surface (half-mirror) C is deposited on the R1 surface of the optical element 2301. The first quarter waveplate B is adhered to the R2 surface of the optical element 2201 and to the R1 surface of the optical element 2202. The polarization-selective transmissive reflective element A is adhered to the R2 surface of the optical element 2101 included in the pupil-plane-side optical system 2100 and to the R1 surface of the optical element 2201 included in the transmissive reflective optical system. In this example, the transmissive reflective surface (half-mirror) C is the second transmissive reflective member, and the polarization-selective transmissive reflective element A is the first transmissive reflective member.

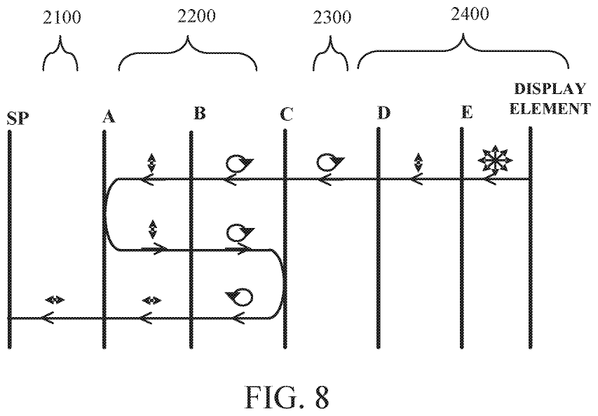

As in Example 1, directions of an optical path and polarization states at respective surfaces of desired light passing through the optical system 2000 are illustrated in FIG. 8. Since they are similar to those in Example 1, a description thereof is omitted.

Also in this example, a maximum half angle of field of 50° is assumed as a design angle of field in a design name. More specifically, a maximum angle of a principal ray of a light beam passing through the pupil plane is 50°.

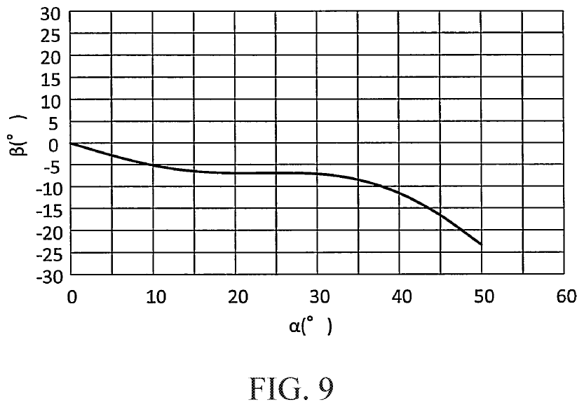

FIG. 9 illustrates an emission angle β (an angle relative to a normal of the display element) of a principal ray relative to a half angle of field α in the optical system 2000 according to this example. In FIG. 9, a horizontal axis represents the half angle of field α (°), and a vertical axis represents the emission angle β (°). As illustrated in FIG. 9, the emission angle β is defined as negative (−) when light is emitted in a direction away from the optical axis, and positive (+) when light is emitted in a direction approaching the optical axis. As illustrated in FIG. 9, the emission angle β at the maximum half angle of field is −23.3°, and a maximum absolute value of the emission angle β is smaller than 30° (when unevenness of light amount distribution is evaluated, an absolute value is used rather than a sign). Thus, the configuration according to this example can suppress unevenness of light amount distribution.

As described above, when only the influence of reflection is considered, a configuration in which both the first transmissive reflective surface and the second transmissive reflective surface have shapes concave toward the pupil plane side, as illustrated in FIG. 3B, is more beneficial than Example 1 in terms of the emission angle β and the half angle of field α. Although the configuration according to this example is less effective than that of FIG. 3B, the configuration is sufficiently useful. Since the first transmissive reflective member is adhered to a curved surface, manufacturing difficulty is increased. On the other hand, since curving the first quarter waveplate further increases manufacturing difficulty, the first quarter waveplate is not laminated on the first transmissive reflective member, but is held as a separate member and maintained planar.

In this example, the optical element 2101 and the optical element 2201, which are refractive optical elements, are cemented via the first transmissive reflective member including the first transmissive reflective surface, and the optical element 2202 and the optical element 2301, which are refractive optical elements, are cemented via the second transmissive reflective member including the second transmissive reflective surface. As in Example 1, by adopting a configuration in which a transmissive reflective member including a transmissive reflective surface is sandwiched by refractive optical elements, refractive power at the transmissive reflective surface can be reduced compared with the case where the transmissive reflective surface contacts air. As a result, when determining a shape of the transmissive reflective surface, the influence of reflective power may mainly be considered. Thus, a degree of freedom in optical design can increase, and the imaging performance can be improved while reducing the emission angle β.

In particular, in this example, unlike Example 1, the first transmissive reflective surface also has a shape concave toward the pupil plane side and has large reflective power, which facilitates securing imaging performance at a wide angle of field. That is, the above configuration can increase the effect. Thereby, as illustrated in FIG. 7B, imaging performance including curvature of field is improved in this example as compared with Example 1. This example can secure a degree of freedom in optical design, and provide an effect of achieving high-definition images.

In this example, a distance from a pupil-facing surface to the display element is 15.5 mm, and thus, as in Example 1, the size (thickness) of the optical system is sufficiently reduced. Also in this example, a focal length is 14.5 mm, and thus, as in Example 1, the size (thickness) of the optical system is sufficiently reduced. Further, in this example, a focal length of the pupil-plane-side optical system is 206.8 mm and a focal length of the panel-side optical system is 23.7 mm, both of which are positive. Thereby, as in Example 1, the focal length can be reduced, and therefore the size (thickness) of the optical system is sufficiently reduced.

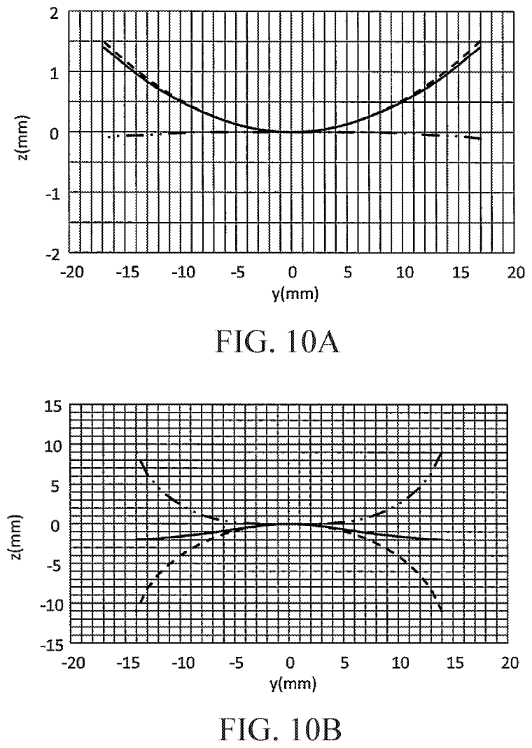

As in Example 1, an aspherical shape of an optical surface that forms an interface with air in the pupil-plane-side optical system and the panel-side optical system will be described. FIG. 10A illustrates, by a solid line, a sectional shape including the optical axis of the R1 surface of the optical element 2101. FIG. 10B illustrates, by a solid line, a sectional shape including the optical axis of the R2 surface of the optical element 2301. In FIGS. 10A and 10B, a horizontal axis represents a distance y (mm), and a vertical axis represents a position z in an optical-axis direction (mm). As in Example 1, both the R1 surface and the R2 surface have shapes that cannot be expressed by conic curves.

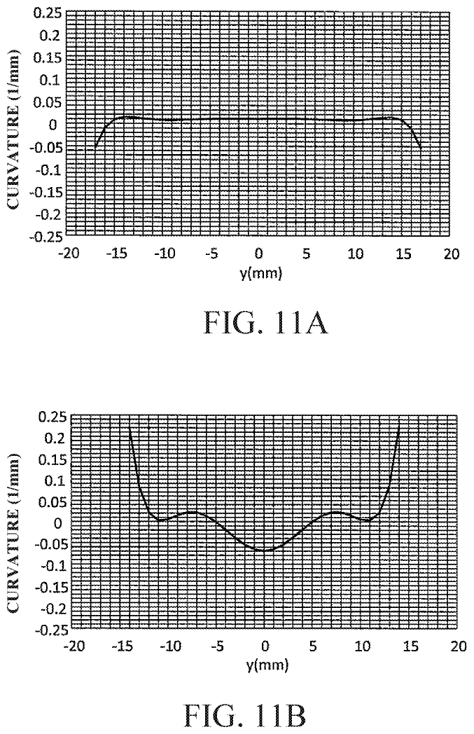

FIG. 11A illustrates a local curvature of a sectional shape including the optical axis of the R1 surface of the optical element 2101. FIG. 11B illustrates a local curvature of a sectional shape including the optical axis of the R2 surface of the optical element 2301. In FIGS. 11A and 11B, a horizontal axis represents a distance y (mm), and a vertical axis represents curvature (1/mm). As in Example 1, both the R1 surface and the R2 surface have shapes in which the curvature reverses toward an off-axis direction relative to an on-axis curvature, that is, shapes having inflection points. Such shapes having local power distributions can provide an effect of reducing the emission angle β while improving curvature of field and astigmatic difference.

Further, as illustrated in FIGS. 11A and 11B, and as in Example 1, the local curvature has five extrema within an effective diameter. By adopting such shapes in which local power changes finely so that the local curvature has three or more extrema, an effect of improving the emission angle β, curvature of field, and astigmatic difference over the entire angle of field is obtained. In particular, at a very wide angle of field as in this example, at least one such aspheric surface may be included.

FIG. 10A further illustrates, by a dotted line, a paraxial curvature surface of the sectional shape including the optical axis of the R1 surface of the optical element 2101, and illustrates, by an alternate long and two short dashes line, a difference from the sectional shape. Similarly, FIG. 10B further illustrates a paraxial curvature surface of the sectional shape including the optical axis of the R2 surface of the optical element 2301 by a dotted line, and illustrates a difference from the sectional shape by an alternate long and two short dashes line.

At the maximum effective diameter end (Φ34) of the R1 surface of the optical element 2101, a sag amount SagA of the sectional shape including the optical axis is 1.41 mm, and a sag amount SagR of the paraxial curvature surface is 1.52 mm. The asphericity is calculated as follows:

$$\vert ( SagA - SagR ) / SagR \vert = 0.071 ( 7.1 \% )$$

Similarly, at the maximum effective diameter end (Φ28) of the R2 surface of the optical element 2301, a sag amount SagA of the sectional shape including the optical axis is −1.97 mm, and a sag amount SagR of the paraxial curvature surface is −11.03 mm. The asphericity is calculated as follows:

$$\vert ( SagA - SagR ) / SagR \vert = 0.822 ( 82.2 \% )$$

Thus, when the asphericity is 30% or more in the R2 surface of the optical element 2301 (one aspheric surface), the effect of this example can be sufficiently obtained. In this example, the asphericity is 50% or more, and therefore the effect can be improved more.

Here, the asphericity of the R1 surface of the optical element 2101 is 30% or less, and although the effect of this example is obtained, the effect is not large. As described above, in this example, both the first transmissive reflective surface and the second transmissive reflective surface have shapes concave toward the pupil plane side, and therefore the configuration is more beneficial than Example 1 in terms of the emission angle β and the half angle of field α. Thus, the effect of this example may be sufficiently obtained even when a plurality of surfaces each having the asphericity of 30% or more are not provided. Thus, the effect of this example can be obtained when at least one of the above-described aspheric surfaces is provided.

In this example, an Abbe number of the optical element 2101 based on the d-line is defined as ν21, and an Abbe number of the optical element 2201 based on the d-line, which is cemented to the optical element 2101 across the first transmissive reflective surface, is defined as ν22. In this case, ν21=57.4 and ν22=27.0, and therefore |ν21−ν22|=30.4. Similarly, an Abbe number of the optical element 2201 based on the d-line is defined as ν22, and an Abbe number of the optical element 2202 based on the d-line, which is cemented to the optical element 2201 across the first quarter waveplate B, is defined as ν23. In this case, ν22=27.0 and ν23=56.0, and therefore |ν22−ν23|=29.0. Similarly, an Abbe number of the optical element 2202 based on the d-line is defined as ν23, and an Abbe number of the optical element 2301 based on the d-line, which is cemented to the optical element 2202 across the second transmissive reflective surface, is defined as ν24. In this case, ν23=56.0 and ν24=22.38, and therefore |ν23−ν24|=33.62.

Thus, using glass materials having an Abbe number difference of 20 or more across the cemented surface can reduce chromatic aberration while reducing an overall optical length. Thereby, as illustrated in FIG. 7B, chromatic aberration over a wide angle of field can be improved in this example as compared with Example 1.

In this example, in particular, the transmissive reflective optical system 2200 has a cemented surface on which the optical element 2201 and the optical element 2202 are cemented across the first quarter waveplate B, and this contributes to reduction of chromatic aberration. Since the shapes of the first transmissive reflective surface and the second transmissive reflective surface contribute to overall imaging performance, degrees of freedom in design for primarily reducing chromatic aberration are not available. That is, cemented lenses across the first transmissive reflective surface and the second transmissive reflective surface have an effect of reducing chromatic aberration, but the effect is limited.

In this example, at least one of the pupil-plane-side optical system, the transmissive reflective optical system, or the panel-side optical system has a cemented surface (that is, includes a cemented lens in which a plurality of lenses are cemented). In this case, the shape of the cemented surface has a degree of freedom in design primarily for reducing chromatic aberration, and therefore a high chromatic aberration reducing effect can be obtained. In particular, in a case where the transmissive reflective optical system has a cemented surface, the effect may be further improved because light passes therethrough three times.

In this example, similarly to Example 1, a side surface of the first transmissive reflective member including the polarization-selective transmissive reflective element A in a direction perpendicular to the optical axis is sealed by cementing outer shapes of the optical element 2101 and the optical element 2201 (P in FIG. 7A), and therefore does not contact air. Thereby, the deterioration in performance or durability due to moisture absorption can be prevented.

In this example, similarly to Example 1, PMMA (acrylic resin) is used as a material of the optical element 2101 that forms the pupil-facing surface facing the pupil plane SP. Thereby, even when stricter antifouling standards are required than usual, a hard coating or antifouling glass cannot be provided, and a cost reduction effect may be obtained.

### Example 3

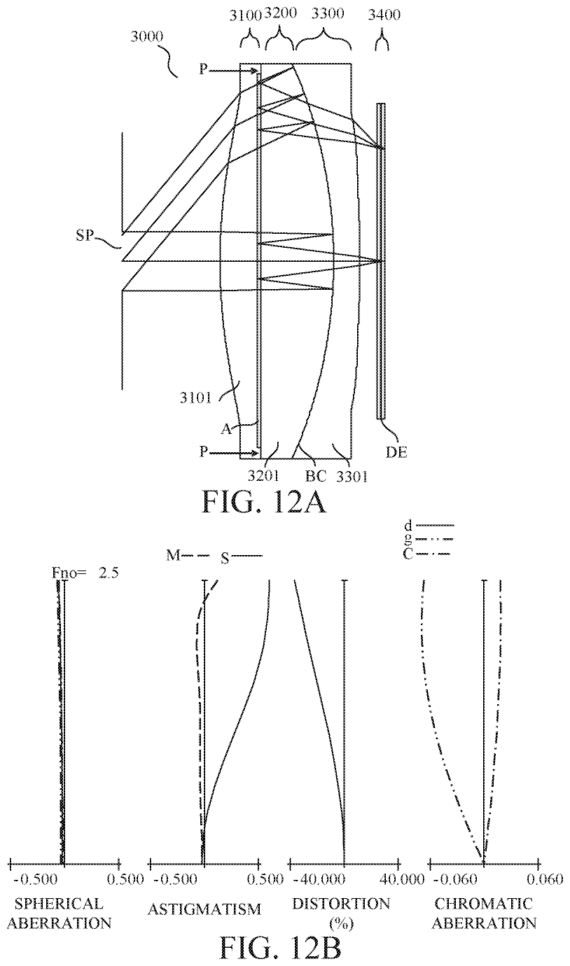

Next, an optical system (observation optical system) 3000 according to Example 3 of the present disclosure will be described. This example will omit a description common to Example 1. FIG. 12A is a sectional view of the optical system 3000. The optical system 3000 includes a pupil-plane-side optical system (first lens unit) 3100, a first transmissive reflective member (A), a transmissive reflective optical system (second lens unit) 3200, a second transmissive reflective member (C), and a panel-side optical system (third lens unit) 3300.

The pupil-plane-side optical system 3100 includes an optical element (first lens) 3101, the transmissive reflective optical system 3200 includes an optical element (second lens) 3201, and the panel-side optical system 3300 includes an optical element (third lens) 3301. Thus, in this example, the pupil-plane-side optical system 3100 includes one optical element, the transmissive reflective optical system 3200 includes one optical element, and the panel-side optical system 3300 includes one optical element. These optical elements (optical elements 3101, 3201, and 3301) refract, reflect, or diffract light. The R1 surface of the optical element 3101 is a curved surface, and the R2 surface thereof is a planar surface. The R1 surface of the optical element 3201 is a planar surface, and the R2 surface thereof is a curved surface. The R1 surface and the R2 surface of the optical element 3301 are both curved surfaces. The optical element 3101 is formed of PMMA (acrylic resin).

A light beam from a panel unit (a display surface of a display element) 3400 passes through the panel-side optical system 3300 and the transmissive reflective optical system 3200, is reflected once by each of the first transmissive reflective surface and the second transmissive reflective surface, passes through the transmissive reflective optical system 3200 and the pupil-plane-side optical system 3100, and travels toward the pupil plane SP. Thereby, an optical image of the panel unit 3400 can be observed from the pupil plane SP at which the exit pupil of the optical system 3000 is located. Light traveling along this optical path is referred to as desired light, and other light is referred to as unnecessary light.

FIG. 12B illustrates aberration diagrams of the optical system 3000 in a case where an eye relief (a distance from the pupil plane SP to a pupil-facing surface of the pupil-plane-side optical system 3100, that is, a lens surface closest to the pupil plane in the pupil-plane-side optical system 3100) is 10 mm and a virtual image is displayed at a position 1400 mm from the pupil plane SP. As illustrated in FIG. 12B, favorable imaging performance is obtained.

In particular, imaging performance including curvature of field is improved as compared with Example 1, and a reason therefor will be described later.

The configuration of the panel unit 3400 is equivalent to that of the panel unit 1400 in Example 1. The transmissive reflective surface (half-mirror) C is deposited on the R1 surface of the optical element 3301. The first quarter waveplate B is adhered to the R1 surface of the optical element 3201 and to the polarization-selective transmissive reflective element A. The polarization-selective transmissive reflective element A is adhered to the R2 surface of the optical element 3101 included in the pupil-plane-side optical system 3100. In this example, the transmissive reflective surface (half-mirror) C is the second transmissive reflective member, and the polarization-selective transmissive reflective element A is the first transmissive reflective member.

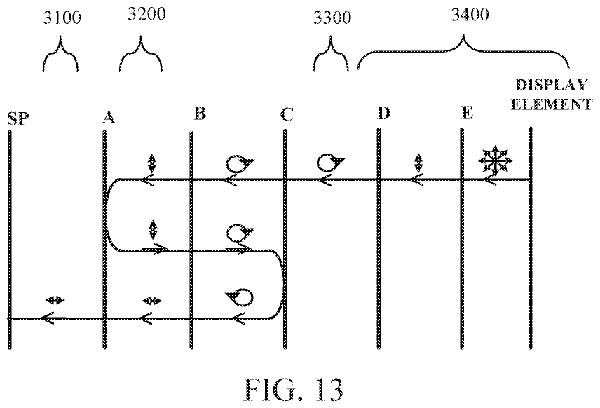

As in Example 1, FIG. 13 illustrates the directions of the optical path and polarization states at respective surfaces of desired light passing through the optical system 3000. Since they are the same as in Example 1, a description thereof will be omitted.

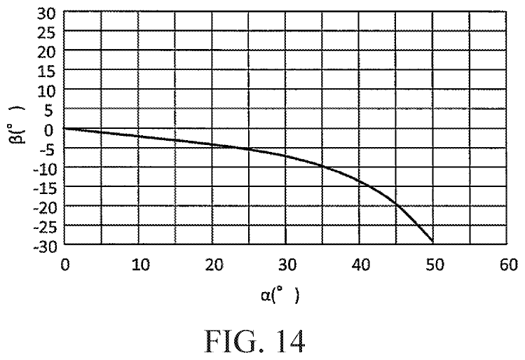

Also in this example, a maximum half angle of field of 50° is assumed as a design angle of field in a design name. More specifically, a maximum angle of a principal ray of a light beam passing through the pupil plane is 50°. FIG. 14 illustrates an emission angle β (an angle relative to a normal of the display element) of a principal ray relative to a half angle of field α in the optical system 3000 of this example. In FIG. 14, a horizontal axis represents the half angle of field α (°), and a vertical axis represents the emission angle β (°). As illustrated in the figure, the emission angle β is defined as negative (−) when light is emitted in a direction away from the optical axis, and positive (+) when light is emitted in a direction approaching the optical axis. As illustrated in FIG. 14, the emission angle β at the maximum half angle of field is −29.1°, and a maximum absolute value of the emission angle β is smaller than 30° (when unevenness of light amount distribution is evaluated, an absolute value is used rather than a sign). That is, the configuration according to this example can suppress unevenness of light amount distribution.

In this example, the optical element 3101 and the optical element 3201, which are refractive optical elements, are cemented via the first transmissive reflective member including the first transmissive reflective surface, and the optical element 3201 and the optical element 3301, which are refractive optical elements, are cemented via the second transmissive reflective member including the second transmissive reflective surface. Similarly to Example 1, by adopting a configuration in which a transmissive reflective member including a transmissive reflective surface is sandwiched by refractive optical elements, refractive power at the transmissive reflective surface can be reduced compared with the case where the transmissive reflective surface contacts air. As a result, when determining a shape of the transmissive reflective surface, the influence of reflective power may mainly be considered. Thus, a degree of freedom in optical design can increase, and imaging performance can be improved while reducing the emission angle β. This example, a degree of freedom in optical design can be secured, and an effect of achieving high-definition images can be obtained.

Further, in this example, the pupil-plane-side optical system, the transmissive reflective optical system, and the panel-side optical system each include one optical element, and therefore the optical system includes a total of three optical elements. Thus, the number of optical elements for obtaining the above-described effects is minimized, which is beneficial in terms of cost and manufacturing.

In this example, a distance from the pupil-facing surface to the display element is 17.0 mm, and thus, as in Example 1, the size (thickness) of the optical system is sufficiently reduced. Also in this example, a focal length is 15.0 mm, and thus, as in Example 1, the size (thickness) of the optical system is sufficiently reduced. Further, in this example, a focal length of the pupil-plane-side optical system is 112.2 mm and a focal length of the panel-side optical system is 179.8 mm, both of which are positive. Thus, as in Example 1, the focal length may be reduced, and therefore the size (thickness) of the optical system can be reduced.

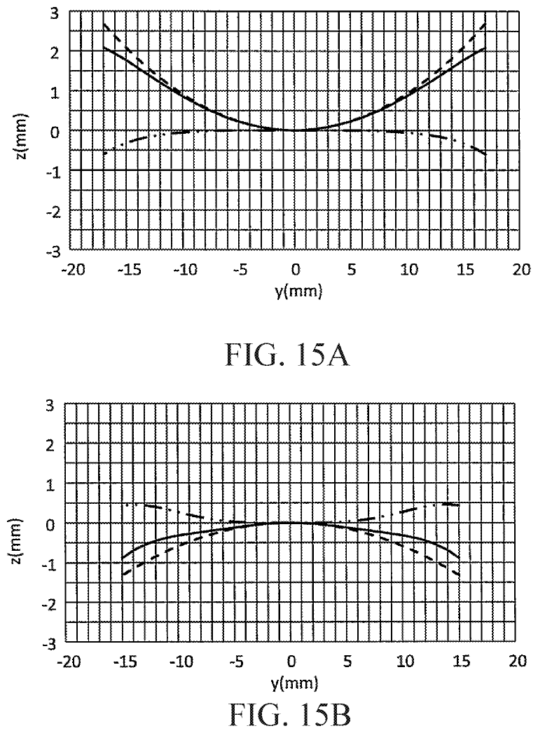

As in Example 1, an aspherical shape of an optical surface that forms an interface with air in the pupil-plane-side optical system and the panel-side optical system will be described. FIG. 15A illustrates, by a solid line, a sectional shape including the optical axis of the R1 surface of the optical element 3101. FIG. 15B illustrates, by a solid line, a sectional shape including the optical axis of the R2 surface of the optical element 3301. In FIGS. 15A and 15B, a horizontal axis represents a distance y (mm), and a vertical axis represents a position z in an optical-axis direction (mm). As in Example 1, both the R1 surface and the R2 surface have shapes that cannot be expressed by conic curves.

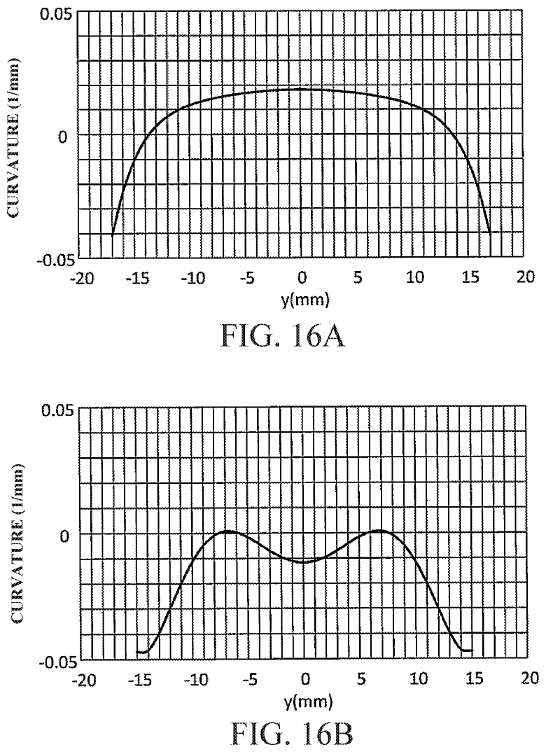

FIG. 16A illustrates a local curvature of a sectional shape including the optical axis of the R1 surface of the optical element 3101. FIG. 16B illustrates a local curvature of a sectional shape including the optical axis of the R2 surface of the optical element 3301. In FIGS. 16A and 16B, a horizontal axis represents a distance y (mm), and a vertical axis represents curvature (1/mm). As in Example 1, both the R1 surface and the R2 surface have shapes in which the curvature reverses toward an off-axis direction relative to an on-axis curvature, that is, shapes having inflection points. Such shapes having local power distributions can provide an effect of reducing the emission angle β while improving curvature of field and astigmatic difference.

Further, as illustrated in FIG. 16B, and as in Example 1, the local curvature has five extrema within an effective diameter. By adopting such shapes in which local power changes finely so that the local curvature has three or more extrema, an effect of improving the emission angle β, curvature of field, and astigmatic difference over the entire angle of field is obtained. In particular, at least one such aspheric surface can be included at a very wide angle of field as in this example.

FIG. 15A further illustrates, by a dotted line, a paraxial curvature surface of the sectional shape including the optical axis of the R1 surface of the optical element 3101, and illustrates, by an alternate long and two short dashes line, a difference from the sectional shape. Similarly, FIG. 15B further illustrates, by a dotted line, a paraxial curvature surface of the sectional shape including the optical axis of the R2 surface of the optical element 3301, and illustrates, by an alternate long and two short dashes line, a difference from the sectional shape.

At the maximum effective diameter end (Φ34) of the R1 surface of the optical element 3101, a sag amount SagA of the sectional shape including the optical axis is 2.08 mm, and a sag amount SagR of the paraxial curvature surface is 2.68 mm. The asphericity is calculated as follows:

$$\vert ( SagA - SagR ) / SagR \vert = 22.3 \%$$

Similarly, at the maximum effective diameter end (Φ30) of the R2 surface of the optical element 3301, a sag amount SagA of the sectional shape including the optical axis is −0.89 mm, and a sag amount SagR of the paraxial curvature surface is −1.32 mm. The asphericity is calculated as follows:

$$\vert ( SagA - SagR ) / SagR \vert = 32.8 \%$$

Thus, when the asphericity is 30% or more in one aspheric surface, that is, the R2 surface of the optical element 3301, the effect of this example can be sufficiently obtained. Here, the asphericity of the R1 surface of the optical element 3101 is 30% or less, and although the effect of this example is obtained, the effect is not large. As can also be understood from FIG. 12B or 14, this is because, in a balance between imaging performance and the emission angle β, imaging performance is emphasized and the emission angle β is allowed compared with Example 1. Thus, although the effect varies according to a design concept, the effect of this example can be obtained as long as at least one of the above-described aspheric surfaces is included.

In this example, an Abbe number of the optical element 3201 based on the d-line is defined as ν32, and an Abbe number of the optical element 3301 based on the d-line, which is cemented to the optical element 3201 across the second transmissive reflective surface, is defined as ν33. In this case, ν32=57.4 and ν33=22.38, and therefore |ν32−ν33|=33.62. Thus, using glass materials having an Abbe number difference of 20 or more across a cemented surface can reduce chromatic aberration while reducing an overall optical length.

In this example, as in Example 1, a side surface of the first transmissive reflective member including the polarization-selective transmissive reflective element A in a direction perpendicular to the optical axis is sealed by cementing outer shapes of the optical element 3101 and the optical element 3201 (P in FIG. 12A), and therefore does not contact air. Thereby, the deterioration in performance or durability due to moisture absorption can be prevented.

In this example, as in Example 1, PMMA (acrylic resin) is used as a material of the optical element 3101 that forms the pupil-facing surface facing the pupil plane SP. Thereby, even when stricter antifouling standards are required than usual, a hard coating or antifouling glass cannot be provided, and a cost reduction effect can be obtained.

Numerical examples 1 to 3 corresponding to Examples 1 to 3, respectively, will be described below. In surface data in each numerical example, a surface number i represents an i-th surface counted from the pupil plane side. r represents a radius of curvature (mm) of an i-th surface, d denotes a lens thickness or an air gap (mm) between i-th and (i+1)-th surfaces, and nd denotes a refractive index at the d-line of a material of an i-th optical member. νd denotes an Abbe number based on the d-line of the material of the i-th optical member. The Abbe number νd is expressed as follows:

$$vd = ( Nd - 1 ) / ( NF - NC )$$

where Nd, NF, and NC are refractive indices of d-line (587.6 nm), F-line (486.1 nm), and C-line (656.3 nm) in the Fraunhofer line, respectively. An effective diameter indicates a maximum diameter of a region through which light from an original image passes at each surface.

An asterisk “*” appended to a surface number means that the surface has an aspherical shape. The aspherical shape is expressed by the following equation:

$$x ( h ) = \frac{( \frac{{h}^{2}}{r} )}{1 + \sqrt{\{ 1 - ( 1 + k ) {( \frac{h}{r} )}^{2}} \}} + {A}_{4} {h}^{4} + {A}_{6} {h}^{6} + {A}_{8} {h}^{8} + {A}_{10} {h}^{10} +$$

where x is a displacement in the optical-axis direction at a position having a height h from the optical axis based on a surface vertex, R is a paraxial radius of curvature, k is a conic constant, and Ai (i=4, 6, 8, . . . ) are aspherical coefficients of respective orders.

NUMERICAL EXAMPLE 1
UNIT: mm
SURFACE DATA

| Surface No. | r | d | nd | νd |
|---|---|---|---|---|
| 1 (pupil plane) | ∞ | 10.00 | | |
| 2* | 51.000 | 2.70 | 1.49171 | 57.4 |
| 3 | ∞ | 0.30 | 1.52000 | 50.0 |
| 4* | ∞ | 7.80 | 1.54390 | 56.0 |
| 5* | −50.470 | −7.80 | | |
| 6 | ∞ | −0.30 | −1.52000 | 50.0 |
| 7 | ∞ | 0.30 | | |
| 8* | ∞ | 7.80 | 1.54390 | 56.0 |
| 9* | −50.470 | 2.90 | 1.64220 | 22.4 |
| 10* | −19.000 | 1.00 | | |
| 11 | ∞ | 0.30 | 1.52000 | 50.0 |
| 12 | ∞ | 0.10 | 1.52000 | 50.0 |
| 13 | ∞ | 0.40 | 1.51633 | 64.1 |
| 14 | ∞ | (Variable) | | |
| Image Plane | ∞ | | | |

ASPHERIC DATA

2nd Surface
K = −1.00000e+00 A 4 = −3.67428e−05 A 6 = 1.66514e−07
A 8 = −4.76007e−10 A10 = 5.37368e−13 A12 = −5.04034e−16
5th Surface
K = −3.00000e+00 A 4 = −6.65066e−06 A 6 = 5.18014e−09
A 8 = 6.70726e−12 A10 = −3.76426e−14
9th Surface
K = −3.00000e+00 A 4 = −6.65066e−06 A 6 = 5.18014e−09
A 8 = 6.70726e−12 A10 = −3.76426e−14
10th Surface
K = −1.00000e+00 A 4 = 4.75733e−04 A 6 = −4.01516e−06
A 8 = 1.58652e−08 A10 = −2.29360e−11

| | |
|---|---|
| Focal Length | 14.27 |

NUMERICAL EXAMPLE 2
UNIT: mm
SURFACE DATA

| Surface No. | r | d | nd | νd |
|---|---|---|---|---|
| 1 (pupil plane) | ∞ | 10.00 | | |
| 2* | 96.000 | 3.50 | 1.49171 | 57.4 |
| 3* | −97.800 | 0.30 | 1.52000 | 50.0 |
| 4* | −97.800 | 1.50 | 1.60700 | 27.0 |
| 5 | ∞ | 0.30 | 1.52000 | 50.0 |
| 6 | ∞ | 6.10 | 1.54390 | 56.0 |
| 7* | | −38.200 | −6.10 | |
| 8 | ∞ | −0.30 | −1.52000 | 50.0 |
| 9 | ∞ | −1.50 | 1.60700 | 27.0 |
| 10* | −97.800 | −0.30 | −1.52000 | 50.0 |
| 11* | −97.800 | 0.30 | | |
| 12* | −97.800 | 1.50 | 1.60700 | 27.0 |
| 13 | ∞ | 0.30 | 1.52000 | 50.0 |
| 14 | ∞ | 6.10 | 1.54390 | 56.0 |
| 15* | −38.200 | 2.00 | 1.64220 | 22.4 |
| 16* | −14.400 | 1.00 | | |
| 17 | ∞ | 0.30 | 1.52000 | 50.0 |
| 18 | ∞ | 0.10 | 1.52000 | 50.0 |
| 19 | ∞ | 0.40 | 1.51633 | 64.1 |
| 20 | ∞ | (Variable) | | |
| Image Plane | ∞ | | | |

ASPHERIC DATA

2nd Surface
K = −1.00000e+00 A 4 = 3.60054e−06 A 6 = −9.35703e−08
A 8 = 5.14016e−10 A10 = −8.55095e−13
3rd Surface
K = 6.00000e+00 A 4 = 8.43436e−06 A 6 = 1.55821e−09
A 8 = 1.89611e−11
4th Surface
K = 6.00000e+00 A 4 = 8.43436e−06 A 6 = 1.55821e−09
A 8 = 1.89611e−11
7th Surface
K = −1.00000e+00 A 4 = 1.42878e−06 A 6 = −1.21058e−08
A 8 = 3.83502e−11
10th Surface
K = 6.00000e+00 A 4 = 8.43436e−06 A 6 = 1.55821e−09
A 8 = 1.89611e−11
11th Surface
K = 6.00000e+00 A 4 = 8.43436e−06 A 6 = 1.55821e−09
A 8 = 1.89611e−11
12th Surface
K = 6.00000e+00 A 4 = 8.43436e−06 A 6 = 1.55821e−09
A 8 = 1.89611e−11
15th Surface
K = −1.00000e+00 A 4 = 1.42878e−06 A 6 = −1.21058e−08
A 8 = 3.83502e−11
16th Surface
K = −1.00000e+00 A 4 = 3.25883e−04 A 6 = −1.72091e−06
A 8 = 3.57618e−09

| | |
|---|---|
| Focal Length | 14.45 |

NUMERICAL EXAMPLE 3
UNIT: mm
SURFACE DATA

| Surface No. | r | d | nd | νd |
|---|---|---|---|---|
| 1 (pupil plane) | ∞ | 10.00 | | |
| 2* | 55.189 | 3.85 | 1.49171 | 57.4 |
| 3 | ∞ | 0.30 | 1.52000 | 50.0 |
| 4 | ∞ | 7.45 | 1.54390 | 56.0 |
| 5* | −50.388 | −7.45 | | |
| 6 | ∞ | −0.30 | −1.52000 | 50.0 |
| 7 | ∞ | 0.30 | | |
| 8 | ∞ | 7.45 | 1.54390 | 56.0 |
| 9* | −50.388 | 2.70 | 1.64220 | 22.4 |
| 10* | −85.752 | 1.75 | | |
| 11 | ∞ | 0.30 | 1.52000 | 50.0 |
| 12 | ∞ | 0.10 | 1.52000 | 50.0 |
| 13 | ∞ | 0.40 | 1.51633 | 64.1 |
| 14 | ∞ | (Variable) | | |
| Image Plane | ∞ | | | |

ASPHERIC DATA

2nd Surface
K = 0.00000e+00 A 4 = −5.49562e−06 A 6 = 1.36131e−09
A 8 = −9.48412e−12 A10 = −5.32998e−14
5th Surface
K = 0.00000e+00 A 4 = −2.07747e−07 A 6 = 2.51349e−10
A 8 = −2.99711e−12
9th Surface
K = 0.00000e+00 A 4 = −2.07747e−07 A 6 = 2.51349e−10
A 8 = −2.99711e−12
10th Surface
K = 0.00000e+00 A 4 = 4.97609e−05 A 6 = −2.65664e−07
A 8 = 3.67150e−10

| | |
|---|---|
| Focal Length | 14.99 |

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

For example, when the optical system is combined with a display element such as an Organic Light Emitting Diode (OLED) or an Liquid Crystal Display (LCD), electrical processing can be applied on the display side depending on a distortion amount or a lateral chromatic aberration amount. In each example, one of the first transmissive reflective surface and the second transmissive reflective surface may be a polarization-selective transmissive reflective element (a reflective polarizer, polarization beam splitter) PBS. In this case, the other of the first transmissive reflective surface and the second transmissive reflective surface may be a half-mirror having a ratio of transmittance to reflectance of 1:1. However, the ratio of transmittance and reflectance may be changed as required. In each example, the optical system may further include another optical system (lens) on the pupil plane side of the first lens unit. Similarly, in each example, the optical system may further include another optical system (lens) on the display surface side of the third lens unit. In the optical system according to Example 1, at least one additional lens may be inserted in a gap within the second lens unit (between the second lens and the third lens).

As a characteristic of general display elements, a light amount of a light beam emitted from a display element is largest in a normal direction and decreases in proportion to an emission angle. For example, in the optical system disclosed in Japanese Patent No. 6984261, since an emission angle of a light beam corresponding to an angle of field at an end portion from the display element is large, a light amount at an angle of field at an end portion decreases, and the user perceives the end portion of the field of view as dark. On the other hand, each example can provide an optical system capable of reducing an emission angle from a display element.

What is claimed is:

1. An optical system configured to guide a light beam from a display surface to a pupil plane, the optical system comprising, in order from a pupil plane side to a display surface side:
a first lens unit;
a first transmissive reflective member having a first transmissive reflective surface;
a second lens unit;
a second transmissive reflective member having a second transmissive reflective surface; and
a third lens unit,
wherein at least one optical surface of the first lens unit that forms an interface with air is a first aspheric surface, and
wherein at least one optical surface of the third lens unit that forms an interface with air is a second aspheric surface.

2. The optical system according to claim 1, wherein the first transmissive reflective surface is a planar surface.

3. The optical system according to claim 1, wherein a section having an optical axis of at least one of the first aspheric surface or the second aspheric surface has a shape that cannot be expressed by a conic curve.

4. The optical system according to claim 1, wherein a section having an optical axis of at least one of the first aspheric surface or the second aspheric surface has a shape that has an inflection point.

5. The optical system according to claim 1, wherein a section having an optical axis of at least one of the first aspheric surface or the second aspheric surface is a shape that has three or more extrema in a second derivative value.

6. The optical system according to claim 1, wherein, in a section having an optical axis of at least one of the first aspheric surface or the second aspheric surface, the following inequality is satisfied:
$$0.3 \leq \vert ( SagA - SagR ) / SagR \vert$$
where SagR is a sag amount of a paraxial curvature surface at a maximum effective diameter end, and SagA is a sag amount of an aspheric surface.

7. The optical system according to claim 1, wherein refractive powers near an optical axis of the first lens unit and the third lens unit are positive.

8. The optical system according to claim 1, wherein a lens closest to the display surface in the second lens unit and a lens closest to the pupil plane in the third lens unit are cemented via the second transmissive reflective member.

9. The optical system according to claim 1, wherein a lens closest to the display surface in the first lens unit and a lens closest to the pupil plane in the second lens unit are cemented via the first transmissive reflective member.

10. The optical system according to claim 1, wherein the first lens unit includes a first lens,
wherein the second lens unit includes a second lens,
wherein the third lens unit includes a third lens,
wherein the first lens and the second lens are cemented via the first transmissive reflective member, and
wherein the second lens and the third lens are cemented via the second transmissive reflective member.

11. The optical system according to claim 1, wherein a distance from an optical surface facing the pupil plane to the display surface is 20 mm or less.

12. The optical system according to claim 1, wherein a focal length of the optical system is 20 mm or less.

13. The optical system according to claim 1, wherein a maximum angle of a principal ray of a light beam passing through the pupil plane is 30° or more, and
wherein an absolute value of a maximum emission angle of the principal ray from a display element is 35° or less.

14. The optical system according to claim 1, wherein an emission angle of a principal ray from a display element passing through a pupil plane is directed away from an optical axis at an angle of field of an end portion of the display element, and
wherein a diagonal length of a circumscribed square of the display element is 1.6 inches or less.

15. The optical system according to claim 1, wherein the following inequality:
$$20 \leq \vert v 1 - v 2 \vert$$
where ν1 is an Abbe number of one lens among two adjacent lenses based on a d-line and ν2 is an Abbe number of the other lens based on the d-line.

16. The optical system according to claim 1, wherein at least one of the first lens unit, the second lens unit, or the third lens unit includes a cemented lens in which a plurality of lenses are cemented.

17. The optical system according to claim 1, wherein at least one of the first transmissive reflective member or the second transmissive reflective member does not contact air.

18. The optical system according to claim 1, wherein an optical element closest to the pupil plane in the first lens unit is formed of acrylic resin.

19. A display apparatus comprising:
an optical system configured to guide a light beam from a display surface to a pupil plane; and
a display element,
wherein the optical system includes, in order from a pupil plane side to a display surface side, a first lens unit, a first transmissive reflective member having a first transmissive reflective surface, a second lens unit, a second transmissive reflective member having a second transmissive reflective surface, and a third lens unit,
wherein at least one optical surface of the first lens unit that forms an interface with air is a first aspheric surface, and
wherein at least one optical surface of the third lens unit that forms an interface with air is a second aspheric surface.
